(19) United States
(12) Patent Application Publication
(10) Pub. No.: US 2004/0067786 A1
(43) Pub. Date: Apr. 8, 2004

(54) Method and apparatus for securing a cellular telephone

(76) Inventor: Filippo Sanfilippo, Piazza Armerina (IT)

Correspondence Address: Tiberiu Weisz, Esq., Gottlieb Rackman & Reisman, 8th Floor, 270 Madison Avenue, New York, NY, 10016, US

(21) Appl. No.: 10/678,284

(22) Filed: Oct. 3, 2003

(30) Foreign Application Priority Data
Feb. 15, 2002 (IT) 2002U000035

(51) Int. Cl. H04B 7/15

(52) U.S. Cl. 455/575.6; 455/90.3; 455/11.1

(57) ABSTRACT

A securing strap includes a biased coil with a filament and a strap end. The strap end is mounted inside an electronic device such as a cellular telephone. The biased coils is incorporated into an accessory, such as a holster or an armband. The cellular telephone can be attached to or removed from the accesorry, however, it stays secured by the strap.

### RELATED APPLICATIONS

None

### BACKGROUND OF THE INVENTION

1. Field of Invention

This invention pertains to a method and apparatus for securing a cellular telephone to a holster or other accessory without interfering with its operation.

2. Background of the Invention

Cellular telephones are so common that they have become literally a necessity of life. They are used by people of all ages and all walks of life. Moreover, over the years cellular telephones have become very small so that they are easy to carry in a purse, pocketbook, and so on. In order to keep the cellular telephone readily accessible, often cellular telephones are mounted in holsters and other accessories that can be mounted on a belt, the strap of a pocketbook, armbands, and so on. However, because they have become so readily accessible, cellular telephones are also prone to theft, can be easily dropped and broken, or lost.

### SUMMARY OF THE INVENTION

Briefly, the subject application pertains to a method of securing a cellular telephone having two parts to an accessory comprising providing a securing strap having a main portion with a biased coil with a filament and a strap end, incorporating the main portion in the accessory, and forming an interference fit between the two parts to grab said strap end. Preferably, the method further comprises separating said parts, inserting said strap end between said parts and assembling said parts to trap said strap end. The method may further include attaching said strap end to one of said parts and providing an adhesive element for attaching said strap end.

In another aspect of the invention, a method is provided for securing an electronic device having a body and a cover, said body and cover defining a cavity, comprising providing a securing strap having a biased coil with a filament attached to a strap end, coupling the biased coil to an accessory, and mounting said strap end within said cavity. The device may have a battery and the strap end may be secured to said battery by an adhesive and said battery may be mounted within said cavity. The strap end may be coupled to said filament by a coupling. The method may further comprise releasing said device from said accessory by disconnecting said coupling.

In another aspect of the invention a cellular telephone assembly is disclosed comprising a cellular telephone having two parts, an accessory, a coil incorporated in the accessory and having a filament, and a strap end attached to said filament and being secured by an interference fit between the two parts. Preferably the coil is biased so that when said filament is pulled out of the coil and released, it is automatically retracted. The assembly may further comprise an adhesive member attaching said strap end to one of said parts. The two parts define a battery chamber and said cellular telephone includes a battery in said battery chamber and said strap end is attached to said battery.

### BRIEF DESCRIPTION OF THE DRAWINGS

FIG. 1 shows the parts of a cellular telephone with a portion of a strap constructed in accordance with this invention;

FIG. 2 shows the battery of the cellular telephone in its cavity;

FIG. 2A shows the closed cellular telephone with the strap portion extending therefrom;

FIG. 3 shows the assembled cellular telephone with the strap attached to a holster;

FIG. 4 shows the holster and the cellular telephone spaced apart from each other;

FIG. 5 shows an alternate strap attached to an armband.

### DETAILED DESCRIPTION OF THE INVENTION

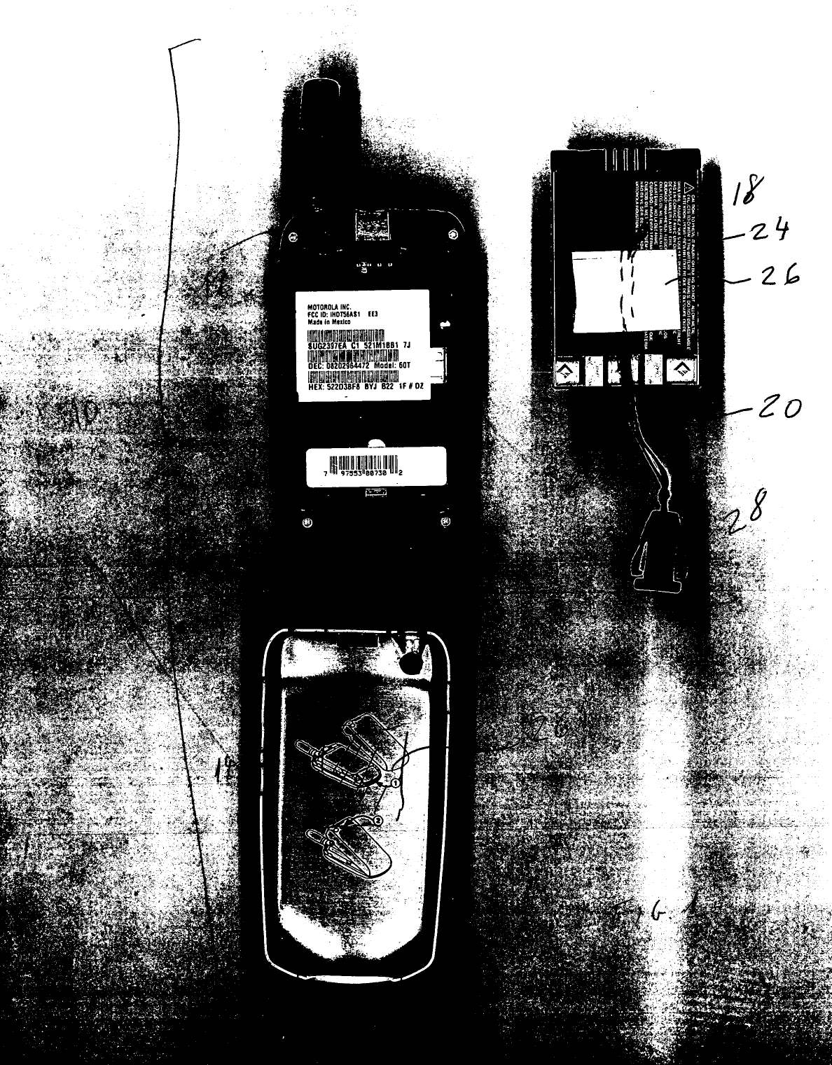

FIG. 1 shows a typical cellular telephone 10 having a main body 12 and a cover 14. A depression 16 is formed in body 14 so that when the cover snaps unto the body 12, a chamber is formed therebetween. This chamber is used to hold battery 18.

According to this invention, a securing strap is provided having two components: an end and a main portion. The strap end 20 is shown in FIG. 1 and it includes one or more threads or strings 22 with string ends 24. The string ends 24 are secured, at least temporarily by an adhesive tape 26. In an alternate embodiment, the string ends 24 can be secured to the body 12, or to the cover by a tape 26′. The strings 22 are attached to a coupling member 28.

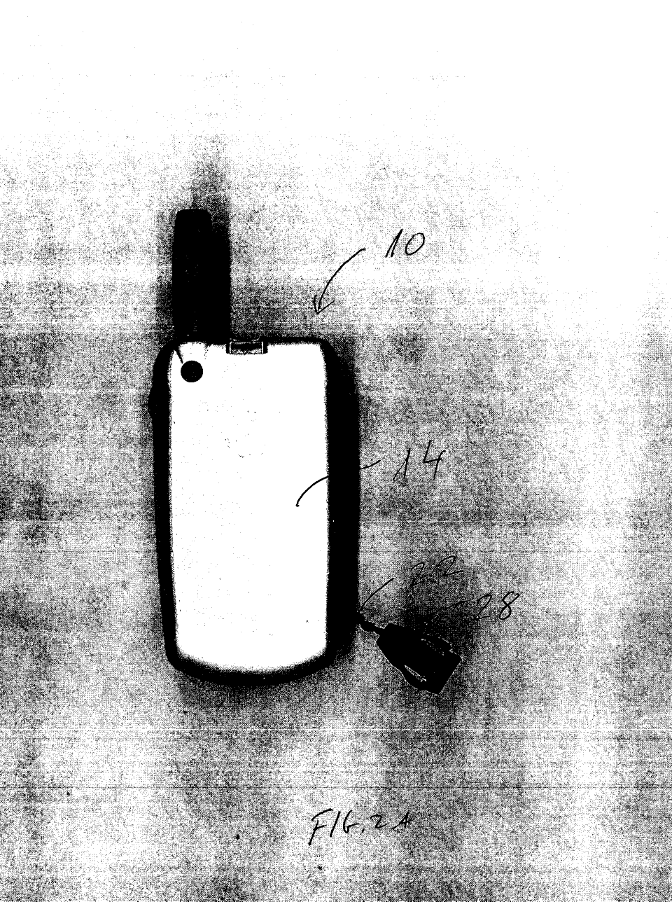

FIG. 2 shows the battery 18 positioned within the depression 16. The string ends 24 and the tape 26 trapped between the battery 18 and the body 12. As shown in FIG. 2A, the cover is snapped over the body 12 with the strap end 20 extending outwardly. The cover 14 fits snugly over the body 12 but its sufficiently flexible to accommodate the strings 24. In this manner, a friction or interference fit is formed between the body 12 and cover 14 which engages and holds the strings 24 tightly. An interference fit is also formed between the battery and the body thereby further holding or grabbing the strap end.

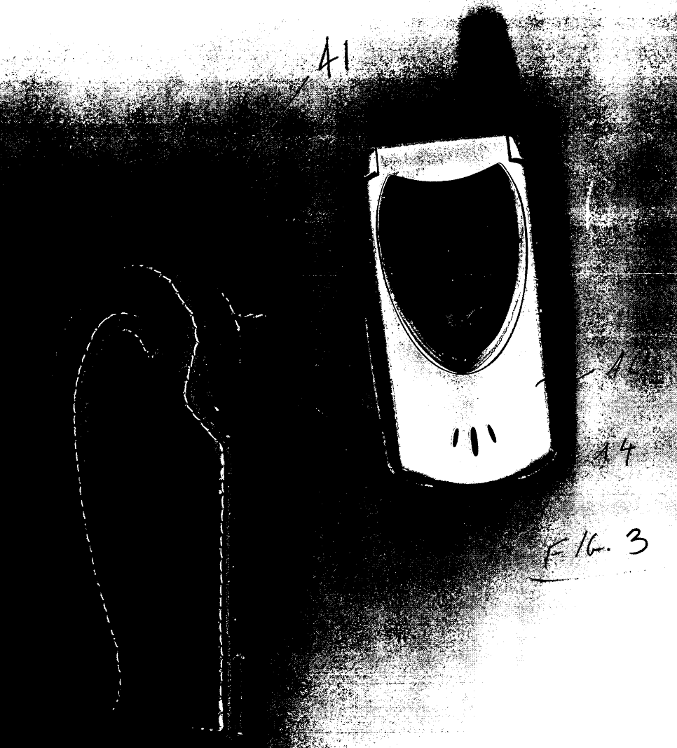

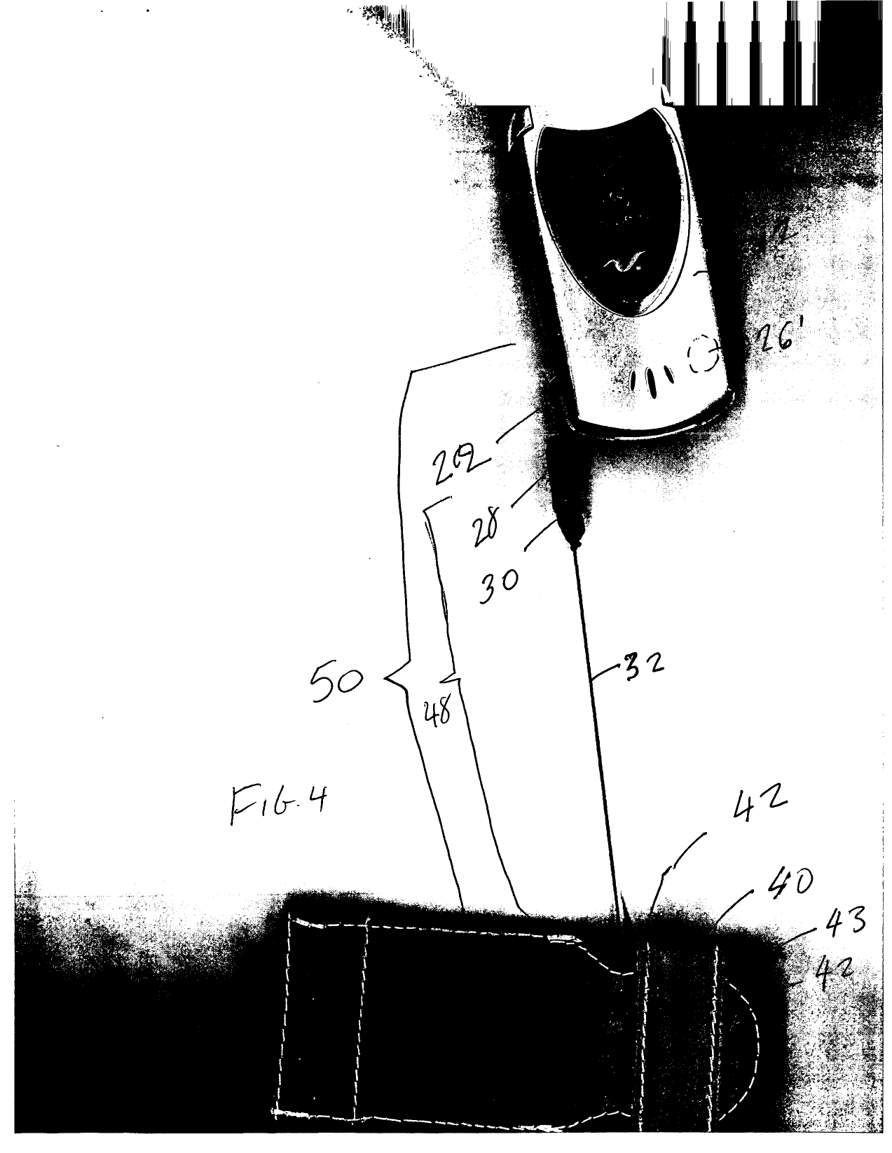

FIGS. 3 and 4 show the cellular telephone 10 attached to a holster 40. The holster 40 is formed with a pocket 42. Within the pocket 42 there is a biased coil 44. The filament 32 of the coil 44 can be pulled out of pocket and when it is released, it is drawn back into the pocket 42 by a spring or rubber band (not shown). Mechanisms of this type are well known in the art.

The filament 32 is attached to another coupling member 30. The coupling member 30 mates with the coupling member 28 but these two members can be manually disengaged from each other when desired. Thus the main portion of the securing strap consists of coil 44 with its filament 32 terminating with coupling member 30.

In summary, the present invention provides a securing strap 50 coupling cellular telephone 10 to an accessory such as holster 40. The securing strap includes a main portion 48 and a strap end 20.

Normally, the cellular telephone 10 is stored in the holster 40. When a customer wants to use the cellular telephone 10, he removes it as shown in FIG. 3 and then pulls it away as shown in FIG. 4 with the filament 32 extending cellular telephone 10 and the holster 40. When the user completes his conversation, he replaces the cellular telephone 10 into the holster 40 and the filament is automatically retracted into the pocket 42. The cellular telephone 10 can be readily separated from the holster 40 by decoupling members 28 and 30.

In FIGS. 1, 2, 2A, 3 and 4 coupling member 30 is a plastic male member that snaps into plastic female member 28 as shown. Other types of coupling members may be used to achieve the same result. Alternatively the coupling members may be omitted and the strap end can be integral with the filament.

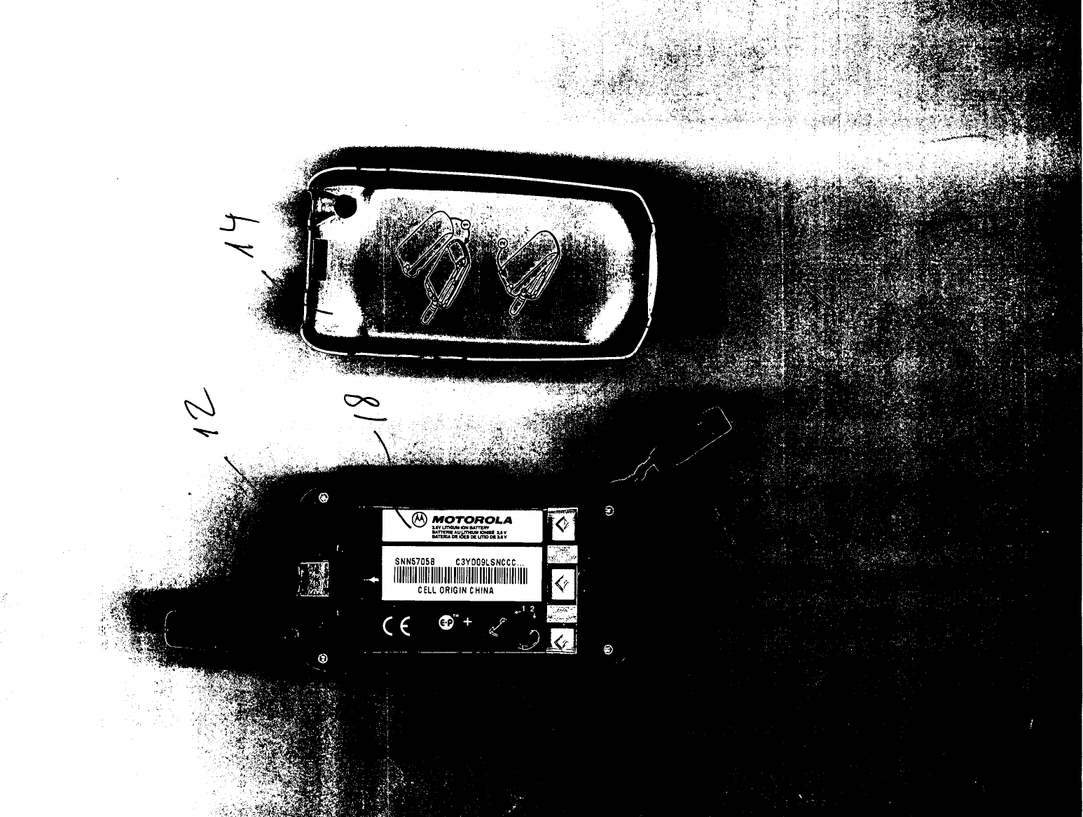

In the previously described embodiment, the holster 40 is made of leather, plastic or other material and is adapted to be mounted on a belt, or other similar elements. FIG. 5 shows a securing strap 50′ used to attach a cellular telephone to an arm band 60. In this Figure, the arm band 60 is provided with a small fabric holster 40′ having a pocket 42′ holding a coil (not shown). Filament 32 extends out of the pocket 42′ and terminates with a closed hook 30 that can be selectively opened. The strap end 20 terminates in a loop 28′ inserted into the hook 30′.

The holster 40 is formed with two flat members 41, 43. At one end of holster the two members are separated slightly thereby forming a space for the pocket 42, as seen in FIG. 3.

The securing strap 50 can be used to secure a cellular telephone or other similar device having a removable portion that can form with interference fit to grab the strings 22.

While the preferred preferred method of securing the string end 20 to the cellular telephone is through the interference fit, another means may be used as well. For example, the string end 20 may be attached to the body 12 by a button having a layer of adhesive, as indicated in FIG. 4 by numeral 26′.

While the invention has been described with reference to several particular embodiments, it is to be understood that these embodiments are merely illustrative of the principles of the invention. Accordingly, the embodiments described in particular should be considered as exemplary, not limiting, with respect to the following claims.

I claim:

1. A method of securing a cellular telephone having two parts to an accessory comprising:
providing a securing strap having a main portion with a biased coil with a filament and a strap end;
incorporating the main portion in the accessory; and
forming an interference fit between the two parts to grab said strap end.

2. The method of claim 1 further comprising separating said parts, inserting said strap end between said parts and assembling said parts to trap said strap end.

3. The method of claim 2 further comprising attaching said strap end to one of said parts.

4. The method of claim 3 further comprising providing an adhesive element for attaching said strap end.

5. A method of securing an electronic device having a body and a cover, said body and cover defining a cavity, comprising:
providing a securing strap having a biased coil with a filament attached to a strap end;
coupling the biased coil to an accessory; and
mounting said strap end on said device with said filament extending between said accessory and said device.

6. The method of claim 5 wherein said device includes a battery and wherein said strap end is secured to said battery and said battery is mounted within said cavity.

7. The method of claim 5 wherein said strap end is secured to one of said body and said cover.

8. The method of claim 5 wherein strap end is coupled to said filament by coupling further comprising releasing said device from said accessory by disconnecting said coupling.

9. The method of claim 5 further comprising assembling said body and said cover to form an interference fit grabbing said strap part.

10. The method of claim 5 further comprising incorporating said coil into said accessory.

11. A cellular telephone assembly comprising:
a cellular telephone;
an accessory;
a coil incorporated in the accessory and having a filament; and
a strap end attached to said filament and being secured to said cellular telephone.

12. The assembly of claim 11 wherein said coil is biased so that when said filament is pulled out of the coil and released, it is automatically retracted.

13. The assembly of claim 11 further comprising an adhesive member attaching said strap end to said cellular telephone.

14. The assembly of claim 13 wherein said adhesive member is attached to an external surface of said cellular telephone.

15. The assembly of claim 11 wherein said cellular telephone is composed of two mating parts and wherein said strap end is inserted between the two parts and held attached to the cellular telephone by an interference fit between the two parts.

16. The assembly of claim 15 wherein said parts define a battery chamber and said cellular telephone includes a battery in said battery chamber and said strap end is attached to said battery.
